(19) United States
(12) Patent Application Publication
(10) Pub. No.: US 2014/0209345 A1
(43) Pub. Date: Jul. 31, 2014

(54) Power Connector for an Electrical Motor

(71) Applicant: Curtiss-Wright Flow Control Corporation, Charlotte, NS (US)

(72) Inventor: Robert MINADEO, Cincinnati, OH (US)

(73) Assignee: Curtiss-Wright Flow Control Corporation, Charlotte, NS (unknown)

(21) Appl. No.: 14/163,706

(22) Filed: Jan. 24, 2014

Related U.S. Application Data
(60) Provisional application No. 61/756,905, filed on Jan. 25, 2013.

(51) Int. Cl. H01R 4/70; H01R 43/20

(52) U.S. Cl. CPC H01R 4/70; H01R 43/20
USPC 174/87; 174/84 R; 29/825

(57) ABSTRACT

A power connector includes a first lug having a securing mechanism to secure a first conductor to the first lug, a second lug having a securing mechanism to secure a second conductor to the second lug, wherein the first lug and the second lug include interlocking features that enable the first and second lugs to be mechanically and electrically coupled and decoupled, and a cold-shrink insulating tube secured over the interlocked first lug and the second lug and sealed against a portion the first conductor and a portion of the second conductor. For applications at higher voltage levels, unique cold-shrink voltage stress control features may be included.

### RELATED APPLICATION

This application claims the benefit of priority to U.S. Provisional Application No. 61/756,905, filed Jan. 25, 2013, the entire contents of which are incorporated herein by reference.

### FIELD

The present invention relates generally to electrical power connectors having sufficient electrical and structural integrity, and environmental protection to be used in safety-critical applications, such as in a nuclear facility.

### BACKGROUND

Various items of industrial equipment, such as motors, require electrical power interfaces. Such power connections can be challenging in safety-critical applications, such as in nuclear power plants, including inside containment areas of nuclear plants, in foundries, refineries, mines, chemical plants, etc. In addition, various cable configurations must be accommodated, including multiple cables connecting to a single cable, connecting cables of significantly different sizes, and connection orientations. There is a need for an improved power connector for use in these applications.

### SUMMARY

Various embodiments include a power connector that includes a first lug having a securing mechanism to secure a first conductor to the first lug, a second lug having a securing mechanism to secure a second conductor to the second lug, wherein the first lug and the second lug include interlocking features that enable the first and second lugs to be mechanically and electrically coupled and decoupled, and a cold-shrink insulating tube secured over the interlocked first lug and the second lug and sealed against a portion the first conductor and a portion of the second conductor.

In addition, for applications at higher voltage levels, unique cold-shrink voltage stress control features are included. In various embodiments, a stress cone may include an inner semi-conductive layer and an outer insulating layer, wherein a portion of the stress cone may lie between a conductor and the insulating tube and disperses electrical charge concentrations over a portion of the insulating tube.

Further embodiments include methods of connecting two conductive leads that include connecting a first lug secured to a first conductor to a second lug secured to a second connector using interlocking features of the first lug and the second lug that enable the first and second lugs to be mechanically and electrically coupled and decoupled, and securing a cold-shrink insulating tube secured over the interlocked first lug and the second lug such that the insulating tube is sealed against a portion of the first conductor and a portion of the second conductor.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIG. 1 is a schematic diagram for a low voltage power connector according to a first embodiment.

FIG. 2 is a schematic diagram a power connector for medium voltage applications according to a second embodiment.

FIG. 3 schematically illustrates the engagement and locking of connector lugs according to an embodiment.

FIG. 4 illustrates a cold-shrink voltage stress cone according to various embodiments.

FIG. 5 illustrates a cold-shrink elastomeric tube used in the various embodiments.

FIG. 6 illustrates a connector lug having a compression-type connection to a cable.

FIG. 7 illustrates a connector lug having a crimp-type connection to a cable.

FIGS. 8A-8B illustrate 2-1 and 3-1 multiple cable power connector adaptors according to embodiments of the invention.

FIG. 9 illustrates a 90° adaptor according to one embodiment.

FIG. 10 illustrates a U-shaped adaptor according to one embodiment.

FIG. 11 illustrates a power connector installed on different sized cables having a cable shim on the smaller cable.

FIG. 12 illustrates a power connector with a brass insert used as a cable conductor interface to a larger sized connector.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

Various embodiments include a power connector, which may be used, for example, for safe and reliable connection of a first conductive lead (e.g., a motor lead) to a second conductive lead (e.g., a field cable lead). The power connector, referred to herein as an EMPC (“Electrical Motor Power Connector”), may be a single-pin, re-connectible interface that shares characteristics of a splice as well as a connector. The EMPC is designed primarily for electric motor power connections but may also be used for various other connections, such as in-line cable connections, conduit/junction box connections, or power distribution connections.

Various embodiments of an EMPC may be used in both low voltage applications (i.e., up to 600V) and medium voltage applications (i.e., up to 8 KV for nuclear applications or 15 KV for non-nuclear applications) and may interface shielded or unshielded field cables ranging from 8 AWG up to 800 MCM with shielded or unshielded device leads. The current capacity of the EMPC is typically limited only by the ampacity of the cables on which it is installed.

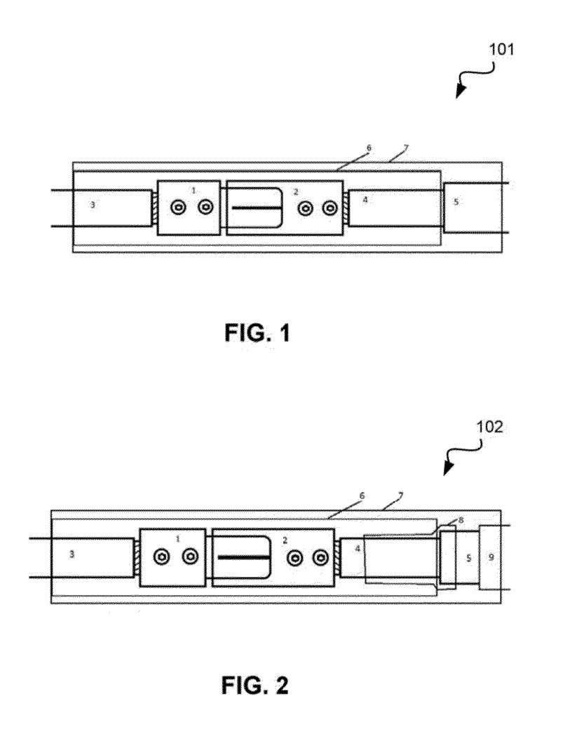

An EMPC 101 according to a first embodiment is schematically illustrated in FIG. 1, and an EMPC 102 according to a second embodiment is schematically illustrated in FIG. 2. The EMPC 101 of FIG. 1 may be used for low voltage applications (i.e., up to 600 V) and the EMPC 102 of FIG. 2 may be used for medium voltage applications (i.e., up to 8 KV).

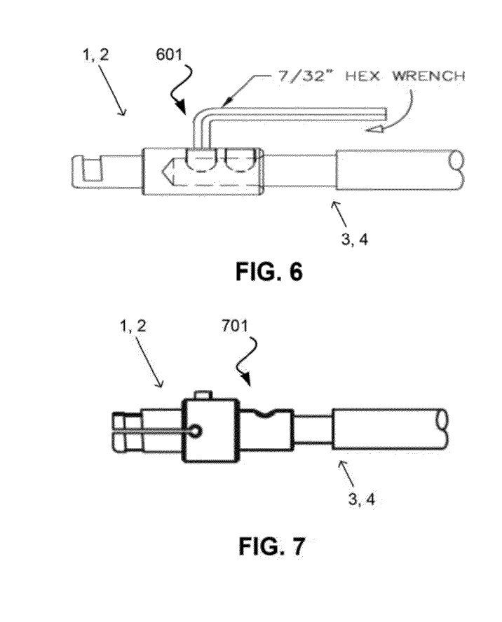

The mechanical connection design of the two EMPC lugs 1, 2 shown in FIGS. 1 and 2, may be a brass/copper twist-lock bayonet design with a locked tensile capacity of greater than 1000 pounds (limited by cable conductor tensile capacity typically). The cable 3, 4 to lug 1, 2 interface design may utilize a compression-type design (e.g., compression screws in the lug barrel), or a crimped lug barrel design. An example of a compression-type interface 601 is shown in FIG. 6, and an example of a crimped-type interface 701 is shown in FIG. 7. The medium voltage EMPC shown in FIG. 2 also includes a voltage stress control feature (e.g., stress cone 8) to preclude partial discharge damage to the field cable 4 at the point of insulation shield 5 cut-back.

The EPMCs may be supplied in kit form for field installation and may include the following constituent parts, with reference to FIGS. 1 and 2:

Female lug 2, utilizing a twist-lock design, comprising a compression barrel with setscrews OR crimp barrel. The lug 2 may be made of a brass alloy and the setscrews may be made of a ferrous material.

Male lug 1 utilizing a twist-lock design, comprising a compression barrel with setscrews OR crimp barrel. The lug 1 may be made of a brass alloy and the setscrews may be made of a ferrous material.

A silicone grease, which may provide an assembly aid and water repellant. The silicone grease may comprise a high dielectric material that prevents partial discharge, as described further below.

An insulating tube 6, which may be a cold-shrink elastomeric tube (e.g., ethylene propylene diene monomer (M-class) rubber (EPDM)), that is sized for the cable OD.

A stress cone tube 8 (FIG. 2 only), which may also be a cold-shrink elastomeric tube (e.g., EPDM) sized for cable OD that provides a voltage stress control feature, as described further below.

A jacketing tube 7 which may be a cold-shrink elastomeric tube (e.g., EPDM), that is sized for the cable OD.

The EMPC may be approximately 12 inches in length, and has an overall envelope diameter dependent on the size of the conductors to be interfaced and may weigh approximately 1 pound for larger sizes.

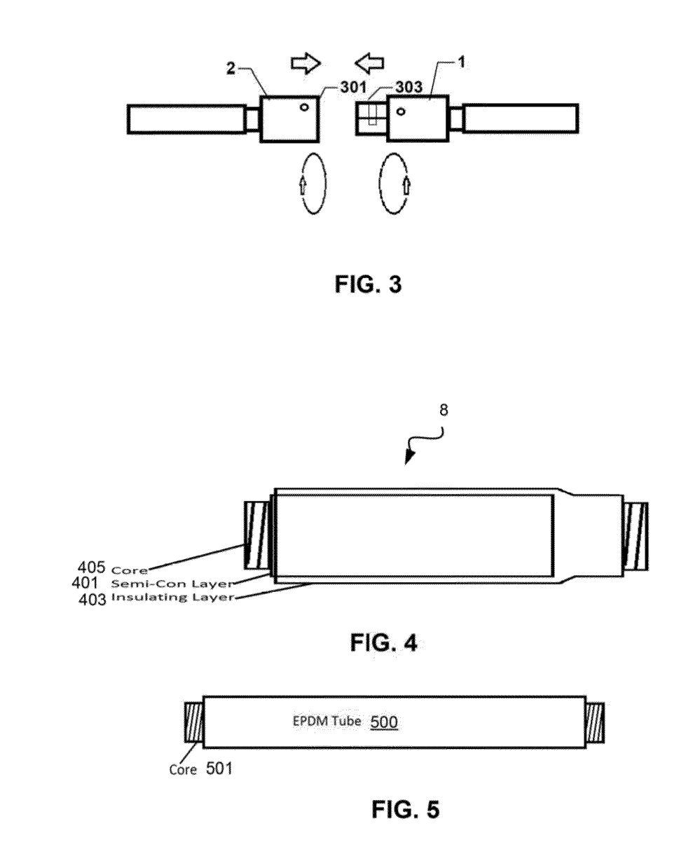

The male and female lugs 1, 2 may be crimp barrel style or compression screw style, for example. The lugs may be copper/brass alloy with steel screws in the compression screw design. The function of the lugs 1, 2 may include electrical conductivity of the circuit current as well as mechanical retention of engagement to prevent circuit interruption due to lug separation. Compression screw type lugs are compatible with crimp type lugs, the only difference being in the lug barrels. FIG. 3 schematically illustrates the connection and disconnection of the lugs 1, 2. For example, the lugs 1, 2 may be connected by aligning a key 301 in the female lug 2 with a slot 303 in the male lug 1 and pushing the lugs 1, 2 together as indicated by straight arrows in FIG. 3. The male lug 1 may be twisted with respect to the female lug 2 (e.g., by 45°) to lock the lugs 1, 2, as schematically illustrated by the circular arrows in FIG. 3. Twisting the lugs 1, 2 in the opposite direction unlocks the lugs, allowing them to be disconnected by pulling them apart.

The lugs 1, 2 may have a variety of sizes to accommodate different cable sizes. For example, a first size lug may have a barrel sized to receive and secure smaller-sized cables (e.g., 8 AWG to 2 AWG), a second lug size may have a barrel sized to receive and secure intermediate sized cables (e.g., 2 AWG to 250 MCM), and a third lug size may have a barrel sized to receive and secure larger sized cables (e.g., 250 MCM or more, such as 250 MCM to 750 MCM). Conductor shims such a bushing insert (described below) may be provided to secure a smaller sized cable within a larger lug barrel.

The insulating tube 6 function is electrical (primary insulation for the connector) and mechanical (prevents conductive fluids from reaching EMPC conductor area to preclude shorting to ground). The jacketing tube 7 has a secondary function of being a backup for the insulating tube with respect to electrical insulation and sealing, but is also a mechanical barrier for abrasion and any incident accident beta radiation for the EMPC insulating tube. Both tubes 6, 7 may be identical cold-shrink EPDM materials with the same or larger dimensions and thickness. An example of a cold-shrink EPDM tube 500 for use as an insulating tube 6 or jacketing tube 7 is shown in FIG. 5. The tube may be slipped over one side prior to connection, positioned over the connector and cables after the connection is made, and the core 501 may be removed to shrink the tube 500 over the cable and connectors as shown in FIGS. 1 and 2.

For non-harsh and non-nuclear applications, it may be acceptable to eliminate the jacketing tube 7, based on evaluation by the end user. The dielectric strength of the insulating tube 6 itself is typically sufficient to establish a 15 KV rating in commercial applications.

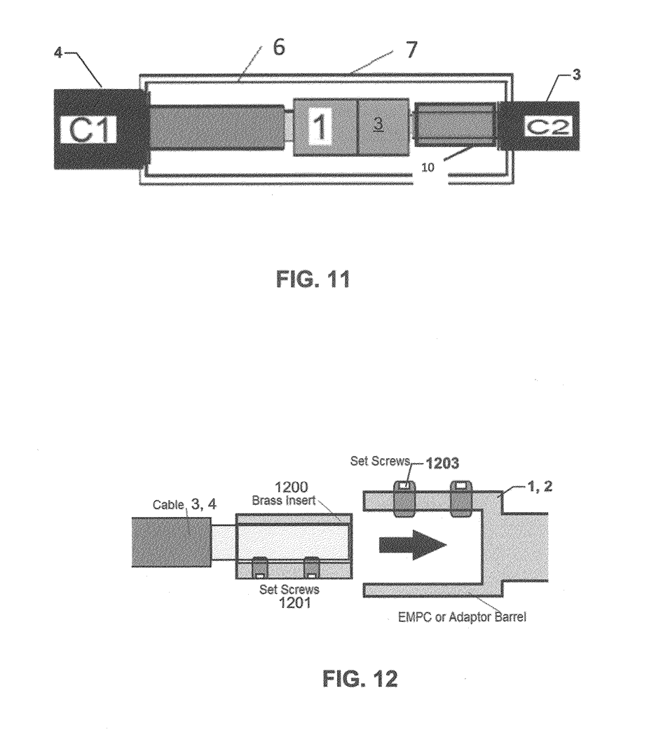

In applications in which the cable diameters are significantly mismatched, a shim tube 10 may be applied to the smaller cable 3, as shown in FIG. 11. Shim tube function is electrical (primary insulation for the connector) and mechanical (prevents conductive fluids from reaching EMPC conductor area to preclude shorting to ground). The shim tube 10 may be a cold-shrink EPDM tube, similar to the insulating tube 6 and the jacketing tube 7, or a direct slip on tube, which may also be EPDM. Shim tubes 10 may be indicated in applications (Low Voltage or Medium Voltage) in which the use range of an insulating tube 6 does not encompass both the field 4 and motor lead 3 diameters. Shim tubes 10 are applied only to the smaller diameter cable, usually the motor lead. In Medium Voltage applications, the stress cone 8 is taken as the outer diameter, as it becomes the sealing surface. The goal of the shim tube 10 is to increase cable effective diameter such that the next larger size insulating tube 6 may be applied since the field and motor lead cable diameters are more similar after applying the shim. Generally, the shim will add 0.200″ to 0.400″ to the diameter of the cable on which it is installed (increase depends on the actual cable diameter).

The stress cone 8 or stress control tube used in medium voltage applications (see FIG. 2) may be a dual-layer EPDM cold-shrink tube. An example of a stress cone 8 is shown in FIG. 4. The stress cone 8 may be comprised of an inner semi-conductive or high dielectric EPDM layer 401 that overlaps the edge of the insulation shield of shielded medium voltage cables and disperses electrical charge concentrations over a length of the cable primary insulation. The outer layer 403 of non-conductive EPDM may be the same EPDM material (but a thinner layer) as the insulating and jacketing 6, 7 tubes described above. The outer non-conducting layer 403 may provide mechanical support for the semi-conductive or high dielectric layer. Its dielectric properties provide additional dielectric strength to the insulating tube 6. The core 405 may be removed during installation to shrink the stress cone 8 over the cable 5 as shown in FIG. 2.

Silicone grease may be applied to the lugs and to the cable insulation adjacent to the lug attachment points. The purpose of the grease is to eliminate corona occurring in air pockets within the connector and to improve moisture resistance. The grease may be a straight chain siloxane grease with amorphous fused silica powder added.

Various embodiments include adaptors for use with a power connector. In order to facilitate connection of various configurations of cables, special adaptors are supplied. The adaptors are all qualified and may be used in any combination as required. These adaptors may include the following illustrative:

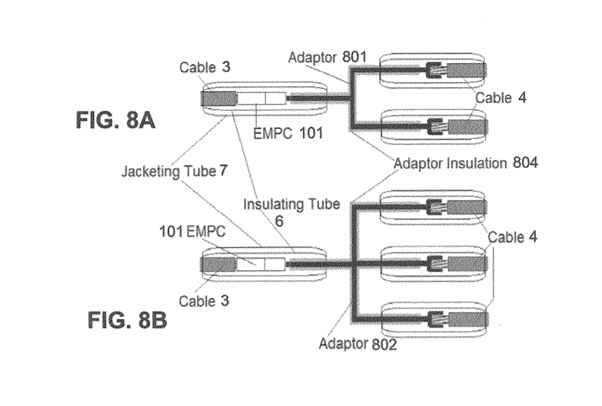

3-1 Adaptor: Permits the connection of three cables to one connector lug. An example of a 3-1 adaptor 802 is shown in FIG. 8B. The adaptor 802 may be constructed of the same brass alloy as the lugs but may be insulated with 125 mils of EPDM or epoxy 804 over the center of the adaptor 802. This adaptor may be used on field or motor leads and is interfaced to the connector lug using the single end of the adaptor inserted into the compression screw barrel of the lug. It is then insulated with an insulating tube and jacketed with a jacketing tube.

2-1 Adaptor: An example of a 2-1 adaptor 801 is shown in FIG. 8A. This adaptor may use the same interface strategy, materials and insulating/jacketing as the 3-1 Adaptor, but for connecting two cables to a single cable.

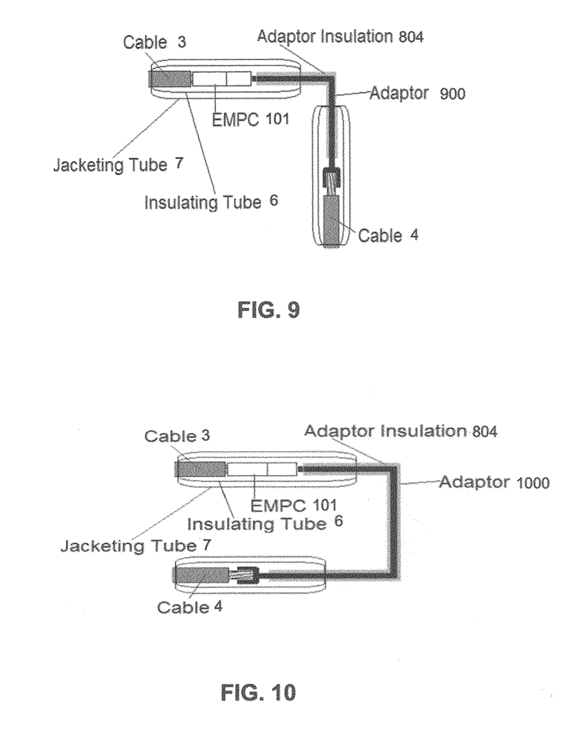

90° Adaptor: An example of this type of adaptor 900 is shown in FIG. 9. This adaptor permits the installation of a 90° bend between cable and connector lug for right angle connections. The same interface strategy, materials and insulating/jacketing as the 3-1 Adaptor may be used.

U Adaptor: An example of this type of adaptor 1000 is shown in FIG. 10. This adaptor permits the installation of a 180° bend (i.e., a “parallel” or “V” orientation) between cable and connector lug for right angle connections. The same interface strategy, materials and insulating/jacketing as the 3-1 Adaptor may be used.

It will be understood that in addition to these illustrative adaptors, various other adaptors may be utilized (e.g., adaptors for connecting more than 3 cables into one cable, or for more than 2 cables into more than 1 cable, or for permitting the installation of cables at bends other than 90° and 180°, as several non-limiting examples). For example, the adaptor may have a bent portion that enables connection of cables at an angle between 30° and 180°.

The adaptors may be configured to provide electrical conductivity (i.e., carry circuit current), provide mechanical retention of cables and locking of lugs, and provide primary insulation of the conductors.

The “Adaptor Insulation” 804 shown in FIGS. 8A-10 may include an elastomeric (e.g., EPDM) covering over the adaptor to provide the primary insulation. Alternatively or in addition, the adaptor insulation may be an epoxy coating applied over the adaptor. For example, the epoxy coating may be a powder coating (multiple layers applied until a minimum thickness, such as 125 mils, is reached. The material may be a silica-filled, single part powder of bisphenol A diglycidal ether with added phenol formaldehyde glycidal ether, TiO₂ filler, and/or cyanoguanadine. It may be applied by powder application in an energized (DC voltage applied to the metallic part) environment to a pre-heated part, which is baked between coating applications until the desired (e.g., 100-150 mils, such as 125 mils) dry film thickness (DFT) is reached.

FIG. 12 illustrates an insert 1200 (bushing insert) that may be used to increase the effective diameter of a cable conductor 3, 4 in the event that there is a mismatch in the size of the cables being connected. The insert may be used in the EMPC illustrated in FIGS. 1 and 2 or in any of the adaptor embodiments shown in FIGS. 8A-10. The bushing insert 1200 may be constructed of the same brass alloy as the lugs and provided with set screws. The purpose of the insert is to facilitate the installation of a smaller conductor than required by the connector lug 1, 2 in the event that a smaller cable is to be connected to a larger cable and their conductor sizes are outside the range of a single lug family. The insert 1200 is installed onto the end of the cable conductor 3, 4 using recessed compression set screws 1201 in order to provide a simulated conductor diameter that is compatible with the lug barrel 1,2. Then, the lug barrel compression screws 1203 are used to secure the insert barrel 1200 to the lug 1, 2. Alternatively, a crimp-type design may be used to secure the cable 3,4 to the insert 1200 and/or the insert 1200 to the lug 1, 2. Use of the insert usually indicates the need for a shim tube (see FIG. 11) to increase the cable insulation diameter to more closely match that of the other cable being connected.

Various embodiments enable a power connector to be easily connected and disconnected. The connection may be made in a matter of minutes (e.g., 5 minutes or less) using simple tools (e.g., cable stripper, torque wrench/crimper, etc.) with excellent configuration control (unlike with heat shrink or tape connections) which is required by law for nuclear safety related applications. Furthermore, if a connector needs to be disassembled for testing or servicing, for example, the outer jacketing and insulating tubes may be easily removed by cutting or scoring and peeling off the material. The conductors may be disconnected by a simple twist to unlock the lugs. The connector may be easily re-connected and with new insulating and jacketing tubes applied. The rapid connection and disconnection of a power connector is particularly advantageous where the connector is located in a harsh environment, such as in a nuclear plant, and may help reduce radiation exposure of the technicians.

Various embodiments of a power connector may maintain integrity over a prolonged useful life (e.g., 20 years or more for insulating tubes and 60 years or more for the connecting lugs). The power connectors may withstand normal radiation levels encountered outside and within containment areas of a nuclear power plant over the useful life of the device, and may also maintain integrity and continue to conduct power during abnormal (e.g., accident) conditions, which may include exposure to elevated radiation levels, temperatures, steam and chemical spray for a prolonged period, such as days, months or even years.

Various embodiments of a power connector according to the invention may satisfy one or more of the following standards and documents:

10CFR50.49 Environmental Qualification of Electrical Equipment Important to Safety for Nuclear Power Plants

IEEE 383-1974/2004—IEEE Standard for Qualification of Electric Cables and Field Splices for Nuclear Power Generating Stations

IEEE 344-1975/1987/2004—IEEE Recommended Practice for Seismic Qualification of Class 1E Equipment for Nuclear Power Generating Stations

IEEE 382-1980/1996/2006—IEEE Standard for Qualification of Safety-Related Valve Actuators (vibration aging)

IEEE 323-1974/1983/2003—IEEE Standard for Qualifying Class 1E Equipment for Nuclear Power Generating Stations

IEEE 572-1985/2006—IEEE Standard for Qualification of Class 1E Connection Assemblies for Nuclear Power Generating Stations

NRC Regulatory Guide 1.100—Seismic Qualification of Electric Equipment for Nuclear Power Plants

NRC Regulatory Guide 1.89—Qualification of Class 1E Equipment for Nuclear Power Plants

NRC Regulatory Guide 1.156—Environmental Qualification of Connection Assemblies for Nuclear Power Plants

The entire contents of these documents are incorporated by reference herein.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A power connector, comprising:
a first lug having a securing mechanism to secure a first conductor to the first lug;
a second lug having a securing mechanism to secure a second conductor to the second lug, wherein the first lug and the second lug include interlocking features that enable the first and second lugs to be mechanically and electrically coupled and decoupled; and
a cold-shrink insulating tube secured over the interlocked first lug and the second lug and sealed against a portion of the first conductor and a portion of the second conductor.

2. The power connector of claim 1, further comprising:
a cold-shrink jacketing tube secured over the insulating tube and sealed against a portion of at least one of the first conductor and the second conductor.

3. The power connector of claim 1, further comprising:
a stress cone comprising an inner semi-conductive layer and an outer insulating layer, wherein a portion of the stress cone lies between a conductor and the insulating tube and disperses electrical charge concentrations over a portion of the insulating tube.

4. The power connector of claim 3, wherein the stress cone comprises a cold-shrink tube.

5. The power connector of claim 1, wherein the cold-shrink insulating tube comprises EPDM rubber.

6. The power connector of claim 2, wherein the cold-shrink jacketing tube comprises EPDM rubber.

7. The power connector of claim 3, wherein the stress cone comprises at least one layer of EPDM rubber.

8. The power connector of claim 1, further comprising:
a silicone grease between the connecting lugs and conductors and the interior of the insulting tube.

9. The power connector of claim 1, further comprising:
an adaptor configured to connect to at least one cable at a first end and having a conductor at a second end that is secured to the first lug or the second lug of the power connector.

10. The power connector of claim 9, wherein the adaptor is configured to connect to a plurality of cables at the first end.

11. The power connector of claim 9, wherein the adaptor may have a bent portion that enables connection of a cable to the first conductor or the second conductor at an angle between 30° and 180°.

12. The power connector of claim 9, wherein the adaptor comprises an insulating epoxy or EPDM over at least a portion of the adaptor.

13. The power connector of claim 1, wherein the first conductor comprises a motor lead and the second conductor comprises a field cable.

14. The power connector of claim 1, wherein the power connector is installed in a nuclear facility.

15. A method of connecting two conductive leads, comprising:
connecting a first lug secured to a first conductor to a second lug secured to a second connector using interlocking features of the first lug and the second lug that enable the first and second lugs to be mechanically and electrically coupled and decoupled; and
securing a cold-shrink insulating tube secured over the interlocked first lug and the second lug such that the insulating tube is sealed against a portion of the first conductor and a portion of the second conductor.

16. The method of claim 15, further comprising:
securing the first conductor to the first lug using a first securing mechanism; and
securing the second conductor to the second lug using a second securing mechanism,
wherein the first securing mechanism and the second securing mechanism comprise at least one of:
a compression mechanism for compressing a conductor within a barrel of the lug, and
a portion of a barrel of the lug that crimps to secure a conductor within the barrel.

17. The method of claim 16, further comprising:
securing at least one of the first conductor and the second conductor to a bushing having an outer diameter sized to securely fit within a barrel of the respective first lug or second lug, wherein securing at least one of the first conductor and the second conductor to a lug comprises securing the bushing to at least one of the first lug and the second lug.

18. The method of claim 15, further comprising:
providing a shim tube over a portion of at least one of the first conductor and the second conductor, wherein securing the cold-shrink insulating tube comprises securing the insulating tube over the shim tube.

19. The method of claim 15, further comprising:
securing a cold-shrink jacketing tube over the insulating tube to seal the jacketing tube against a portion of at least one of the first conductor and the second conductor.

20. The method of claim 15, further comprising:
providing a stress cone having an inner semi-conductive layer and an outer insulating layer such that a portion of the stress cone lies between a conductor and the insulating tube and disperses electrical charge concentrations over a portion of the insulating tube.
